(19) United States
(12) Patent Application Publication
(10) Pub. No.: US 2011/0085552 A1
(43) Pub. Date: Apr. 14, 2011

(54) SYSTEM AND METHOD FOR FORMING VIRTUAL PRIVATE NETWORK

(75) Inventors: Seungwoo HONG, Daejeon (KR); Jong Dae Park, Daejeon (KR); Sung Kee Noh, Daejeon (KR); Ho Yong Ryu, Daejeon (KR); Kyeong Ho Lee, Daejeon (KR); Seong Moon, Daejeon (KR); Pyung-Koo Park, Daejeon (KR); Ho Sun Yoon, Daejeon (KR); Nam Seok Ko, Daejeon (KR); Sun Cheul Kim, Daejeon (KR); Soon Seok Lee, Daejeon (KR); Sung Back Hong, Daejeon (KR)

(73) Assignee: Electronics and Telecommunications Research Institute, Daejeon (KR)

(21) Appl. No.: 12/904,774

(22) Filed: Oct. 14, 2010

(30) Foreign Application Priority Data
Oct. 14, 2009 (KR) 10-2009-0097923
Aug. 9, 2010 (KR) 10-2010-0076561

(51) Int. Cl. H04W 40/00

(52) U.S. Cl. 370/392

(57) ABSTRACT

Technology for forming a virtual private network (VPN) is provided. A VPN gateway that supports mobility with a connection node having a virtual home address (HoA) and a care of address (CoA) includes a mobility support unit, a data security unit, and a virtual address converter. When a packet is transferred from the connection node, the mobility support unit sustains a binding relationship between a home address (HoA) of the connection node and the changed CoA, and processes a mobility tunnel for the packet, thereby generating a first conversion packet. The data security unit performs a security test of the first conversion packet. The virtual address converter converts the HoA of the connection node, which is a source address of the first conversion packet in which the security test is complete, to a private network internal address that can be used in the VPN, thereby generating a second conversion packet.

### CROSS-REFERENCE TO RELATED APPLICATION

This application claims priority to and the benefit of Korean Patent Application No. 10-2009-0097923 and 10-2010-0076561 filed in the Korean Intellectual Property Office on Oct. 14, 2009 and Aug. 9, 2010, the entire contents of which are incorporated herein by reference.

### BACKGROUND OF THE INVENTION

(a) Field of the Invention

The present invention relates to a system and method for forming a virtual private network. More particularly, the present invention relates to a system and method for forming a virtual private network that supports mobility using a virtual home address in which a remote connection node does not change.

(b) Description of the Related Art

In a corporate environment in which the head office and several branches are geographically dispersed, in order to connect the head office and the branches, a method of constructing a private network by leasing a lease line is used. However, because the cost of a lease line for constructing a private network is relatively expensive, in order to more cheaply construct a private network, a public network may be used.

In this way, a network that provides a function of a private network using a public network is referred to as a virtual private network (VPN), and the VPN is formed by connecting an internal private communication network of a corporation and public Internet and thus it is unnecessary to buy and manage separate expensive equipment or software, thereby sharply reducing cost, compared with an existing private network connection method. Because a homeworker, an employee having frequent business trips, and service personnel can be connected to a corporation private network through an Internet service provider and the Internet, data sharing between a head office and a branch and between a branch and a branch or an external employee can be easily performed more easily and cheaply.

In a method of constructing a VPN, it is constructed by providing connectivity using a specific protocol such as a multiprotocol label switching layer 2 virtual private network (MPLS L2VPN), a layer 3 virtual private network (L3VPN), a layer 2 tunneling protocol (L2TP), and a point to point tunneling protocol (PPTP) on the Internet, which is a non-connection type of network, or adding a security function such as Internet protocol security (IPSec) and a secure sockets layer (SSL).

However, the MPLS VPN, the L2TP, and the PPTP simply provide only connectivity without defining data security, which is an important element of the VPN, and the IPSec and the SSL define security end-to-end and thus they are insufficient to define security in end-to-network and network-to-network schemes. Particularly, a node connecting to a corporation private network moves and thus when a connection point of the Internet changes, there is a problem that conventional VPN technologies do not provide connectivity.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method for forming a VPN having advantages of providing a safe security line to a remote user using the VPN and providing a service without disconnecting even when the remote user moves.

An exemplary embodiment of the present invention provides a system for forming a virtual private network (VPN) that supports mobility with a connection node having a virtual home address (HoA) and a care of address (CoA), the system including:

a mobility support unit that generates when a packet transferred from the connection node is tunnel packet, a first conversion packet using the packet; a data security unit that performs a security test of the first conversion packet; and a virtual address converter that generates a second conversion packet by converting the virtual HoA of the connection node, which is a source address of the first conversion packet in which the security test is complete, to a private network internal address that can be used in the VPN.

Another embodiment of the present invention provides a system for forming a VPN that supports mobility with a connection node having a virtual home address (HoA) and a care of address (CoA), the system including:

a virtual address converter that generates, when a packet which is a private network internal address corresponding to the virtual HoA of the connection node as a destination address is transferred from a service server within the VPN to the connection node, a first restoration packet by restoring the private network internal address to the virtual HoA of the connection node; a data security unit that encodes the first, restoration packet; and a mobility support unit that detects the virtual HoA of the connection node from the encoded first restoration packet and that generates a second restoration packet by inserting the CoA for the virtual HoA.

Yet another embodiment of the present invention provides a method of forming a VPN that supports mobility with a connection node having a virtual home address (HoA) and a care of address (CoA), the method including:

generating, when a packet is transferred from the connection node, a first conversion packet by processing a mobility tunnel for the packet; performing a security test of the first conversion packet; and generating a second conversion packet by converting the virtual HoA of the connection node, which is a source address of the first conversion packet in which the security test is complete, to a private network internal address that can be used in the VPN.

Yet another embodiment of the present invention provides a method of forming a VPN that supports mobility with a connection node having a virtual home address (HoA) and a care of address (CoA), the method including:

receiving, when a packet which is a private network internal address corresponding to the virtual HoA of the connection node as a destination address is transferred from an internal service server of the VPN to the connection node, the packet from the internal service server; generating a first restoration packet by restoring the private network internal address to the virtual HoA of the connection node; encoding the first restoration packet and detecting the virtual HoA of the connection node from the encoded first restoration packet; and generating a second restoration packet by inserting CoA corresponding to the virtual HoA of the connection node in the first restoration packet.

### BRIEF DESCRIPTION OF THE DRAWINGS

FIG. 1 is a diagram schematically illustrating a VPN according to an exemplary embodiment of the present invention.

FIG. 2 is a diagram illustrating a configuration of a VPN gateway of a corporation private network of FIG. 1.

FIG. 3 is a diagram illustrating an example of inputting a packet to a corporation private network according to an exemplary embodiment of the present invention.

FIG. 4 is a flowchart illustrating an order of processing a packet that is input to a corporation private network according to an exemplary embodiment of the present invention.

FIG. 5 is a diagram illustrating an example of a packet that is output from a corporation private network according to an exemplary embodiment of the present invention.

FIG. 6 is a flowchart illustrating an order of processing a packet that is output from a corporation private network according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements.

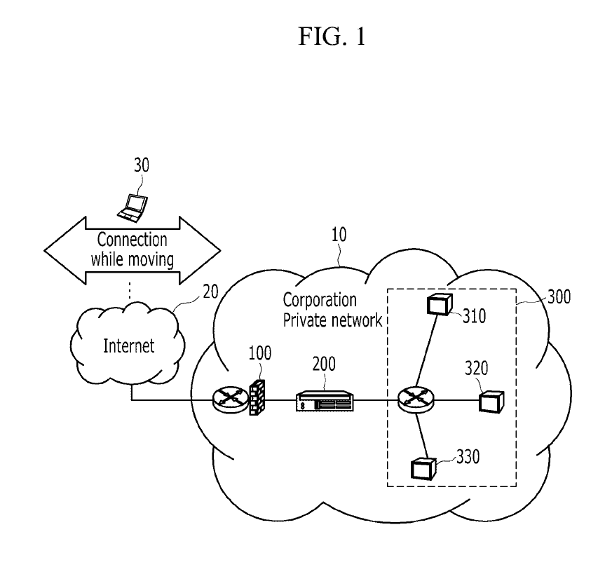

FIG. 1 is a diagram schematically illustrating a VPN according to an exemplary embodiment of the present invention.

As shown in FIG. 1, a VPN according to an exemplary embodiment of the present invention includes a corporation private network 10, an Internet 20, and a connection node 30 that support mobility.

The corporation private network 10 includes a firewall 100, a VPN gateway 200, and a service server 300.

The firewall 100 protects the internal corporation private network 10 from an abnormal connection node (not shown) connecting through the Internet 20.

When the connection node 30 tries to connect to the inside of the corporation private network 10 through the Internet 20, the VPN gateway 200 provides a safe security line to a remote user and provides a remote moving service to connect without disconnecting even when the remote user moves. That is, the VPN gateway 200 allows the connection node 30 to safely connect to the service server 300 within the corporation private network 10.

The service server 300 includes service servers that provide an internal service to the connection node 30, such as a groupware server 310, a video server 320, and a file server 330. In an exemplary embodiment of the present invention, the groupware server 310, the video server 320, and the file server 330 are illustrated as a service server, but the service server is not limited thereto, and may include various servers that can provide an internal service.

The connection node 30 is connected to the Internet 20 through a fixed wired connection network to be connected to the VPN gateway 200. Alternatively, the connection node 30 is connected to the Internet 20 through a wireless connection network that can move to be connected to the VPN gateway 200. That is, the connection node 30 connects to the corporation private network 10 through the Internet 20 using a virtual home address (hereinafter referred to as a “HoA”) that does not change while moving and a care of address (hereinafter referred to as a “CoA”), which is an IP address that continuously changes while moving. When the connection node 30 connects to the VPN gateway 200, the HoA is a virtual address that is allocated to the connection node 30 after the VPN gateway 200 authenticates the connection node 30.

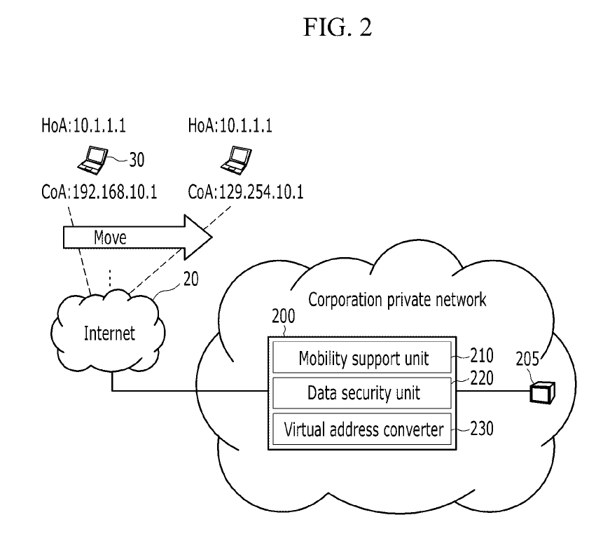

FIG. 2 is a diagram illustrating a configuration of a VPN gateway of the corporation private network of FIG. 1.

As shown in FIG. 2, the VPN gateway 200 of the corporation private network 10 according to an exemplary embodiment of the present invention includes a mobility support unit 210, a data security unit 220, and a virtual address converter 230.

Even when the CoA continuously changes as an Internet connection point changes while the connection node 30 moves, the mobility support unit 210 provides a safe security line to a remote user. Specifically, the mobility support unit 210 continuously sustains a binding relationship between the HoA and the CoA, and allows the connection node 30 to be not disconnected by tunneling the HoA to the CoA.

For example, when the HoA that is allocated to the connection node 30 is 10.1.11, the connection node 30 moves and thus when an Internet connection point changes, the CoA of the connection node 30 is changed from a CoA 192.168.10.1 before moving to a CoA 122.254.10.1 after moving. In such a case, the mobility support unit 210 provides a service to connect to the corporation private network 10 without disconnecting even when moving by sustaining a binding relationship between a CoA 122.254.10.1 and a HoA 10.1.11 that are changed after moving while continuously sustaining a binding relationship between a CoA 192.168.10.1 and a HoA 10.1.11 before moving.

Because the connection node 30 is transferred through the Internet in which security is weak, the data security unit 220 encodes and decodes data that are transferred between the connection node 30 and the VPN gateway 200.

The virtual address converter 230 uses a private network internal address corresponding to a HoA that is allocated to the connection node 30 in order to use the HoA that is allocated to the connection node 30 in the service server 300 of the corporation private network 10. That is, because the HoA is a random address that can recognize only the VPN gateway 200, the virtual address converter 230 converts a HoA of a packet that is transferred from the connection node 30 to a corresponding private network internal address in order to use it within the corporation private network 10.

Specifically, when the connection node 30 transfers a packet from the outside to the corporation private network 10 through the Internet 20, the virtual address converter 230 converts the HoA to a private network internal address corresponding to a HoA that can be used within the corporation private network 10 and performs communication. In contrast, when the corporation private network 10 transfers a packet from the inside to the connection node 30 through the Internet 20, the virtual address converter 230 converts the HoA to a HoA corresponding to a private network internal address of the connection node 30 and performs communication.

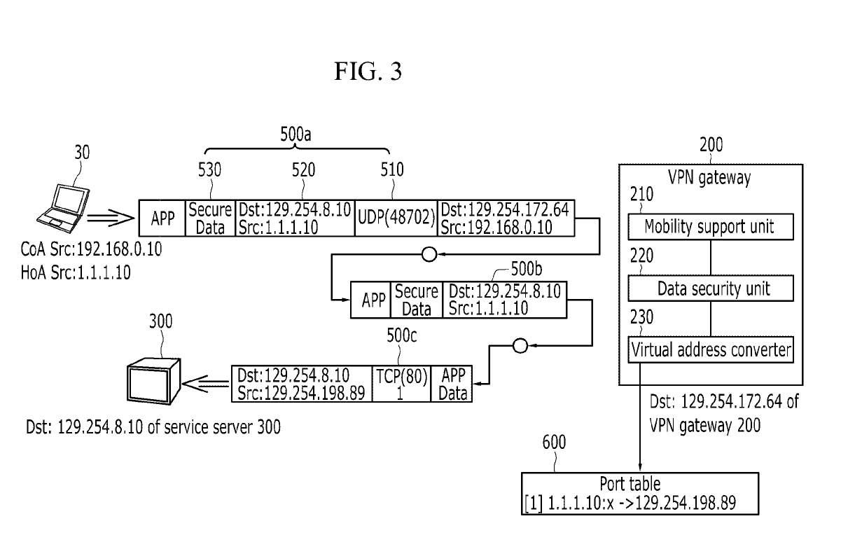

FIG. 3 is a diagram illustrating an example of inputting a packet to a corporation private network according to an exemplary embodiment of the present invention.

Referring to FIGS. 2 and 3, a packet 500a that is transferred from the connection node 30 to the VPN gateway 200 of the corporation private network 10 according to an exemplary embodiment of the present invention includes a UDP tunnel header 510, an IP header 520, and a security header 530.

The UDP tunnel header 510 includes a CoA source address (hereinafter referred to as a “CoA Src”) of the connection node 30 and a destination address (hereinafter referred to as a “Dst Add”) for the VPN gateway 200. In an exemplary embodiment of the present invention, the CoA source address of the connection node 30 is assumed to be 192.168.0.10 and the destination address for the VPN gateway 200 is assumed to be 129.254.172.64.

The IP header 520 includes a HoA source address (hereinafter referred to as a “HoA Src”) of the connection node 30 and a destination address (hereinafter referred to as a “Dst Add”) for the service server 300 within the VPN gateway 200. In an exemplary embodiment of the present invention, the HoA source address of the connection node 30 is assumed to be 1.1.1.10 and the destination address for the service server 300 is assumed to be 129.254.8.10.

The security header 530 includes security data that are related to security.

When the packet 500a is input from the connection node 30 to the VPN gateway 200 of the corporation private network 10, the mobility support unit 210 of the VPN gateway 200 determines whether the packet 500a is a tunnel packet by testing the UDP tunnel header 510 of a first input packet 500a and detects a CoA Src 192.168.0.10 of the connection node 30 and a Dst Add 129.254.172.64 for the VPN gateway 200 in order to traverse a tunnel. The mobility support unit 210 generates a first conversion packet 500b by removing the UDP tunnel header 510 and transfers the generated first conversion packet 500b to the data security unit 220. That is, the first conversion packet 500b according to an exemplary embodiment of the present invention includes an IP header 520 and a security header 530.

The data security unit 220 receives the first conversion packet 500b from the mobility support unit 210. The data security unit 220 completes a security test by performing a security test and security data processing of a packet that is transferred through the Internet in which security is weak. The data security unit 220 transfers a packet in which a security test is complete to the virtual address converter 230.

The virtual address converter 230 receives the first conversion packet 500b in which a security test is complete from the data security unit 220. The virtual address converter 230 converts an address of the HoA Src 1.1.1.10 in order to use the HoA Src 1.1.1.10 of the connection node 30, which is a source address of the first conversion packet 500b, in the service server 300 of the corporation private network 10 and generates a second conversion packet 500c. The virtual address converter 230 transmits the second conversion packet 500c to the service server 300, which is a destination. That is, the virtual address converter 230 converts the HoA Src 1.1.1.10 of the connection node 30, which is a source address of the first conversion packet 500b to correspond to a private network internal address 129.254.198.89, and thus generates a second conversion packet 500c, and stores the second conversion packet 500c at a first entry of a port table 600. Here, in the port table 600, the HoA Src 1.1.1.10 of the connection node 30, the private network internal address 129.254.198.89 of the corporation private network 10 corresponding thereto, and a number 1 of an entry that is used for address conversion are displayed.

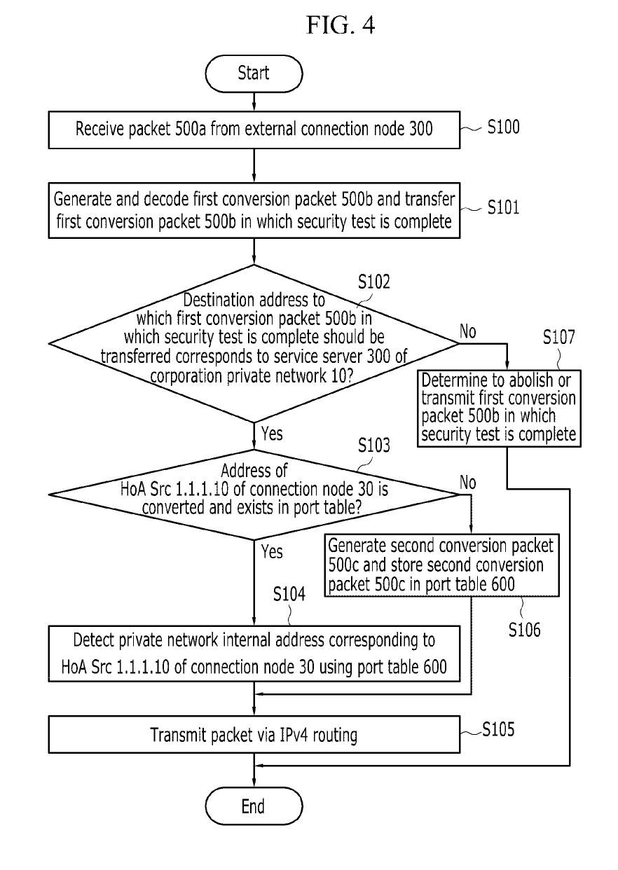

FIG. 4 is a flowchart illustrating an order of processing a packet that is input to a corporation private network according to an exemplary embodiment of the present invention.

Referring to FIGS. 3 and 4, the VPN gateway 200 of the corporation private network 10 according to an exemplary embodiment of the present invention receives a packet 500a from the connection node 30 that is positioned at the outside (S100).

The mobility support unit 210 of the VPN gateway 200 determines whether the packet 500a is a tunnel packet by testing the packet 500a, and generates a first conversion packet 500b by traversing a tunnel. The mobility support unit 210 transfers the generated first conversion packet 500b to the data security unit 220. Accordingly, the data security unit 220 receives the first conversion packet 500b and completes a security test by decoding the encoded first conversion packet 500b, and transfers the first conversion packet 500b in which a security test is complete to the virtual address converter 230 (S101).

The virtual address converter 230 determines whether a destination address to which the first conversion packet 500b in which a security test is complete should be transferred corresponds to the service server 300 of the corporation private network 10 (S102).

If a destination address to which the first conversion packet 500b in which a security test is complete should be transferred corresponds to the service server 300 of the corporation private network 10, the virtual address converter 230 determines whether an address of a HoA Src 1.1.1.10 of the connection node 30 is converted and exists in the port table 600 before converting the HoA Src 1.1.1.10 of the connection node 30, which is a source address of a purity packet, to a private network internal address 129.254.198.89 (S103).

If an address of a HoA Src 1.1.1.10 of the connection node 30 is converted and exists in the port table 600, the virtual address converter 230 detects a private network internal address corresponding to the HoA Src 1.1.1.10 of the connection node 30 using the port table 600 and transmits a packet via general IPv4 routing (S104 and S105).

If an address of a HoA Src 1.1.1.10 of the connection node 30 is converted and does not exist in the port table 600 at step S103, the virtual address converter 230 generates a second conversion packet 500c by converting the HoA Src 1.1.1.10 of the connection node 30 to a private network internal address 129.254.198.89 and adds a new entry by storing the second conversion packet 500c in the port table 600 (S106).

If a destination address to which the first conversion packet 500b in which a security test is complete should be transferred does not correspond to the service server 300 of the corporation private network 10 at step S102, the virtual address converter 230 determines the destination address as an address of another destination, not that of the service server 300, thereby determining whether to abolish a purity packet or to transfer a packet by defining a series of policies (S107).

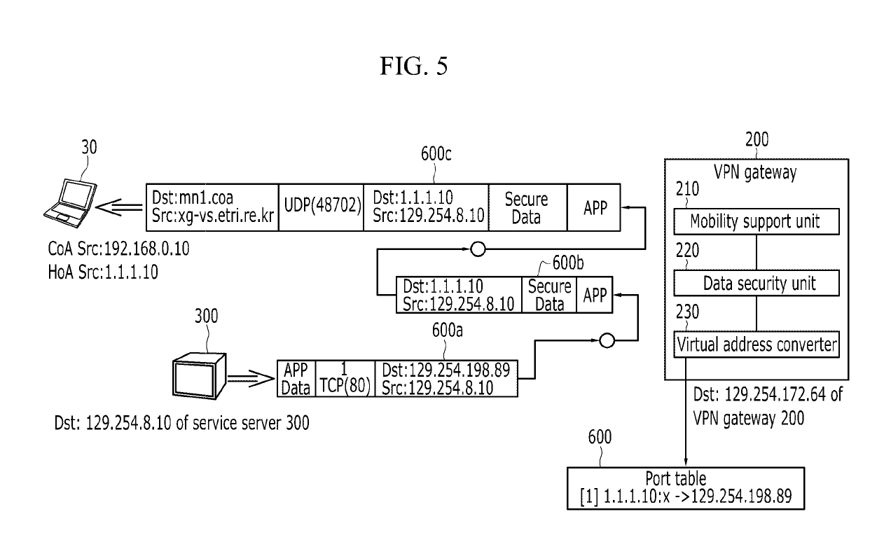

FIG. 5 is a diagram illustrating an example of a packet that is output from a corporation private network according to an exemplary embodiment of the present invention.

In FIG. 5, a packet 600a that is transferred from the service server 300 to the VPN gateway 200 according to an exemplary embodiment of the present invention has a structure corresponding to the second conversion packet 500c that is output to the service server 300, which is shown in FIG. 3, a first restoration packet 600b has a structure corresponding to the first conversion packet 500b, and a second restoration packet 600c has a structure corresponding to the packet 500a that is input from the connection node 30, and therefore a detailed description of the structure will be omitted.

Referring to FIGS. 3 and 5, when a packet is transferred to the service server 300 of the corporation private network 10 according to an exemplary embodiment of the present invention, the HoA Src 1.1.1.10 of the connection node 30 is converted to a private network internal address 129.254.198.89 that can be used in the service server 300 of the corporation private network 10 and is stored at a first entry and the second conversion packet 500c is generated, and thus when the virtual address converter 230 of the VPN gateway 200 receives a packet from the service server 300, the virtual address converter 230 receives the packet 600a using the private network internal address 129.254.198.89 as a destination address.

The virtual address converter 230 determines whether a first entry of the received packet 600a exists in the port table 600. The virtual address converter 230 detects the HoA Src 1.1.1.10 of the connection node 30 corresponding to the private network internal address 129.254.198.89, which is a destination address of the packet 600a using the port table 600. The virtual address converter 230 restores the private network internal address 129.254.198.89 to the HoA Src 1.1.1.10 of the detected connection node 30 and transfers the HoA Src 1.1.1.10 to the data security unit 220.

The data security unit 220 receives the first restoration packet 600b in which the destination address of the packet 600a is restored to the HoA Src 1.1.1.10 of the connection node 30. The data security unit 220 encodes the first restoration packet 600b and transfers the first restoration packet 600b to the mobility support unit 210.

The mobility support unit 210 receives the first restoration packet 600b in which encoding is complete from the data security unit 220 and detects the HoA Src 1.1.1.10 of the connection node 30, which is a destination address of the first restoration packet 600b. The mobility support unit 210 inserts a UDP tunnel header for the HoA Src 1.1.1.10 of the connection node 30 into the first restoration packet 600b, thereby generating a second restoration packet 600c. The mobility support unit 210 transfers the second restoration packet 600c to the connection node 30 through the Internet 20.

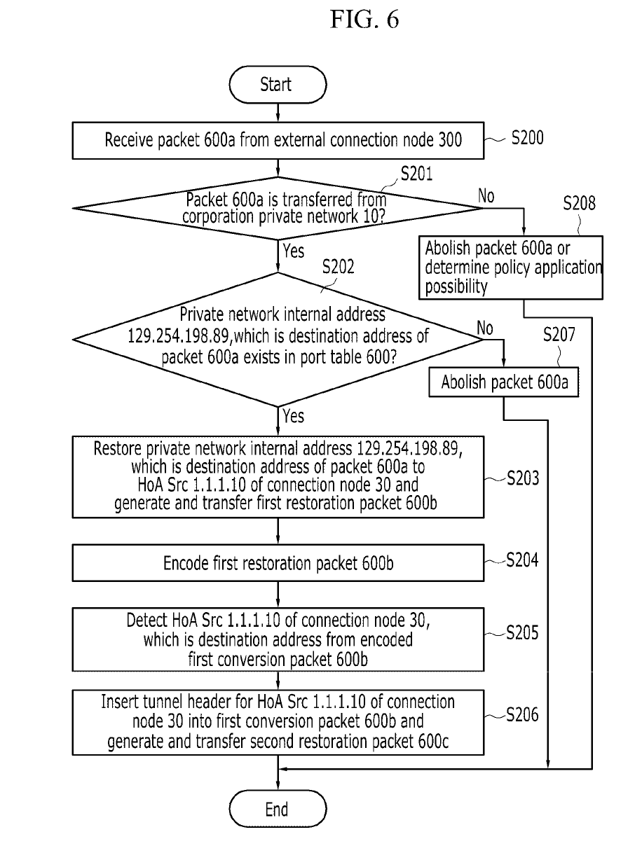

FIG. 6 is a flowchart illustrating an order of processing a packet that is output from a corporation private network according to an exemplary embodiment of the present invention.

Referring to FIGS. 5 and 6, the VPN gateway 200 of the corporation private network 10 according to an exemplary embodiment of the present invention receives a packet 600a using a private network internal address 129.254.198.89 as a destination address from the service server 300 of the corporation private network 10 (S200).

The virtual address converter 230 of the VPN gateway 200 determines whether the packet 600a is transferred from the corporation private network 10 (S201).

If the packet 600a is transferred from the corporation private network 10, the virtual address converter 230 determines whether the private network internal address 129.254.198.89, which is a destination address of the packet 600a, exists in the port table 600 using the packet 600a (S202).

If the private network internal address 129.254.198.89, which is a destination address of the packet 600a, exists in the port table 600, the virtual address converter 230 detects a HoA Src 1.1.1.10 of the connection node 30 corresponding to the private network internal address 129.254.198.89, which is a destination address of the packet 600a, using the port table 600. The virtual address converter 230 generates a first restoration packet 600b by restoring the private network internal address 129.254.198.89, which is a destination address of the packet 600a to the HoA Src 1.1.1.10 of the detected connection node 30, and transfers the first restoration packet 600b to the data security unit 220 (S203).

The data security unit 220 receives the first restoration packet 600b. The data security unit 220 encodes the first restoration packet 600b and transfers the first restoration packet 600b in which encoding is complete to the mobility support unit 210 (S204).

The mobility support unit 210 detects the HoA Src 1.1.1.10 of the connection node 30, which is a destination address, from the encoded first restoration packet 600b (S205). The mobility support unit 210 inserts an UDP tunnel header for the HoA Src 1.1.1.10 of the connection node 30 into the first restoration packet 600b and generates a second restoration packet 600c. The mobility support unit 210 transfers the second restoration packet 600c to the connection node 30 through the Internet 20 (S206).

If the private network internal address 129.254.198.89, which is a destination address of the packet 600a, does not exist in the port table 600 at step S202, the virtual address converter 230 abolishes the packet 600a (S207).

If the packet 600a is not transferred from the corporation private network 10 at step S201, the virtual address converter 230 determines whether to abolish the packet 600a or to transfer the packet by defining a series of policies (S208).

In this way, according to an exemplary embodiment of the present invention, a private network internal address that can be used within an actual corporation private network is allocated to correspond to a HoA of the connection node and thus communication is performed, whereby even when the connection node is moved, a service can be provided without disconnecting and a safe security line can be provided to a remote user.

The foregoing exemplary embodiment of the present invention may be not only embodied through a system and a method, but may also be embodied through a program that executes a function corresponding to a configuration of the exemplary embodiment of the present invention or through a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for forming a virtual private network (VPN) that supports mobility with a connection node having a virtual home address (HoA) and a care of address (CoA), the system comprising:
a mobility support unit that generates, when a packet transferred from the connection node is tunnel packet, a first conversion packet using the packet;
a data security unit that performs a security test of the first conversion packet; and
a virtual address converter that generates a second conversion packet by converting the virtual HoA of the connection node, which is a source address of the first conversion packet in which the security test is complete, to a private network internal address that can be used in the VPN.

2. The system of claim 1, wherein the mobility support unit generates the first conversion packet by traversing a tunnel when the packet is the tunnel packet.

3. The system of claim 1, wherein the virtual address converter generates the second conversion packet according to whether the virtual HoA of the connection node is converted to the private network internal address and exists in a table.

4. The system of claim 1, wherein the packet comprises a UDP tunnel header, an IP header, and a security header.

5. The system of claim 4, wherein the mobility support unit generates the first conversion packet by removing the UDP tunnel header.

6. The system of claim 5, wherein in the second conversion packet, the private network internal address is set to a source address, and an address of a service server within the VPN is set as a destination address.

7. The system of claim 6, wherein the virtual address converter transfers the second conversion packet to the service server, which is ghe destination address of the second conversion packet.

8. A system for forming a VPN that supports mobility with a connection node having a virtual home address (HoA) and a care of address (CoA), the system comprising:
a virtual address converter that generates, when a packet which is a private network internal address corresponding to the virtual HoA of the connection node as a destination address is transferred from a service server within the VPN to the connection node, a first restoration packet by restoring the private network internal address to the virtual HoA of the connection node;
a data security unit that encodes the first restoration packet; and
a mobility support unit that detects the virtual HoA of the connection node from the encoded first restoration packet and that generates a second restoration packet by inserting the CoA for the virtual HoA.

9. The system of claim 8, wherein the virtual address converter abolishes the packet or determines policy application possibility when the packet is not transferred from the service server.

10. The system of claim 8, wherein the virtual address converter determines whether the first restoration packet is generated according to whether the private network internal address exists in a table.

11. The system of claim 8, wherein the packet comprises an IP header and a security header.

12. A method of forming a VPN that supports mobility with a connection node having a virtual home address (HoA) and a care of address (CoA), the method comprising:
generating, when a packet is transferred from the connection node, a first conversion packet by processing a mobility tunnel for the packet;
performing a security test of the first conversion packet; and
generating a second conversion packet by converting the virtual HoA of the connection node, which is a source address of the first conversion packet in which the security test is complete, to a private network internal address that can be used in the VPN.

13. The method of claim 12, wherein the packet comprises a UDP tunnel header, an IP header, and a security header.

14. The method of claim 12, wherein the generating of a first conversion packet comprises:
determining whether the packet is a tunnel packet by testing the UDP tunnel header in order to process the mobility tunnel; and
generating the first conversion packet by removing the UDP tunnel header when the packet is tunnel packet.

15. The method of claim 13, wherein the generating of a second conversion packet comprises:
determining whether the private network internal address corresponding the virtual HoA of the connection node is stored in a port table;
converting, if the private network internal address corresponding the virtual HoA of the connection node is not stored, the virtual HoA of the connection node, which is the source address of the first conversion packet, to the private network internal address; and
detecting, if the private network internal address corresponding the virtual HoA of the connection node is stored, the private network internal address corresponding to the virtual HoA of the connection node, using the port table.

16. A method of forming a VPN that supports mobility with a connection node having a virtual home address (HoA) and a care of address (CoA), the method comprising:
receiving, when a packet which is a private network internal address corresponding to the virtual HoA of the connection node as a destination address is transferred from an internal service server of the VPN to the connection node, the packet from the internal service server;
generating a first restoration packet by restoring the private network internal address to the virtual HoA of the connection node;
to encoding the first restoration packet and detecting the virtual HoA of the connection node from the encoded first restoration packet; and
generating a second restoration packet by inserting the CoA corresponding to the virtual HoA of the connection node in the first restoration packet.

17. The method of claim 16, wherein the receiving of the packet comprises:
determining whether the packet is input from the service server;
abolishing the packet if it is not input from the service server, or determining policy application possibility; and
determining, if the packet is input from the service server, whether the private network internal address exists in a port table.

18. The method of claim 17, wherein the determining of whether the private network internal address exists in the port table comprises:
abolishing the packet if the private network internal address does not exist in the port table; and
detecting the virtual HoA of the connection node corresponding to the private network internal address using the port table if the private network internal address exists in the port table.

19. The method of claim 16, wherein the second restoration packet comprises a UDP tunnel header, an IP header, and a security header.
